(19) United States
(12) Patent Application Publication
(10) Pub. No.: US 2017/0060874 A1
(43) Pub. Date: Mar. 2, 2017

(54) VISUALLY DISPLAYING PERFORMANCE OF CONTENT ON A SOCIAL NETWORK

(71) Applicant: Linkedln Corporation, Mountain View, CA (US)

(72) Inventors: Valter Ernesto Sciarrillo, San Francisco, CA (US); Rezaur Rahman, San Francisco, CA (US)

(21) Appl. No.: 14/968,528

(22) Filed: Dec. 14, 2015

Related U.S. Application Data
(60) Provisional application No. 62/212,420, filed on Aug. 31, 2015.

(51) Int. Cl. G06F 17/30; H04L 12/58

(52) U.S. Cl. CPC G06F 17/3053; H04L 51/32; G06F 17/30598; G06F 17/30864

(57) ABSTRACT

A social network can use at least one computer processor for visually displaying performance of content on the social network. The computer processor can receive a selection of a time frame and an audience on a user interface provided to a user. The selected audience can include a plurality of users of the social network specified by category. The computer processor can retrieve, from the social network, topic data relating the content to user engagement of the content during the selected time frame by the selected audience. The content is categorized by topic. The computer processor can rank the topics, of the retrieved topic data, as a function of the user engagement. The computer processor can create a visual representation of the highest-ranked topics including indicia indicating relative levels of the user engagement for corresponding topics. The computer processor can display the visual representation on the user interface.

### CROSS-REFERENCE TO RELATED APPLICATION

This application claims the benefit of U.S. Provisional Application No. 62/212,420, filed Aug. 31, 2015 and titled “VISUALLY DISPLAYING PERFORMANCE OF CONTENT ON A SOCIAL NETWORK”, which is hereby incorporated by reference herein in its entirety.

### BACKGROUND

A social network system is a computer or web-based service that enables users to establish links or connections with persons for the purpose of sharing information with one another. Some social network systems aim to enable friends and family to communicate and share with one another, while others are specifically directed to business users with a goal of establishing professional networks and sharing business information. For purposes of the present disclosure, the terms “social network” and “social network system” are used in a broad sense and are meant to encompass services aimed at connecting friends and family (often referred to simply as “social networks”), as well as services that are specifically directed to enabling business people to connect and share business information (also commonly referred to as “social networks” but sometimes referred to as “business networks” or “professional networks”).

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various examples discussed in the present document.

FIG. 1 is a block diagram showing the functional components of a social networking service, in accordance with some embodiments.

FIGS. 2-7 show examples of user interfaces, each user interface showing a respective visual representation that displays performance of content on a social network, in accordance with some embodiments.

FIG. 8 shows an example of a method for visually displaying performance of content on a social network, in accordance with some embodiments.

FIG. 9 illustrates a block diagram of an example of a machine upon which any one or more of the techniques (e.g., methodologies) discussed herein may perform, in accordance with some embodiments.

### DETAILED DESCRIPTION

In the following, a detailed description of examples will be given with references to the drawings. It should be understood that various modifications to the examples may be made. In particular, elements of one example may be combined and used in other examples to form new examples.

Many of the examples described herein are provided in the context of a social or business networking website or service. However, the applicability of the inventive subject matter is not limited to a social or business network system. The present inventive subject matter is generally applicable to a wide range of information services.

A social network system is a service provided by one or more computer systems accessible over a network that allows members of the service to build or reflect social networks or social relations among members. Typically, members construct profiles, which may include personal information such as the member's name, contact information, employment information, photographs, personal messages, status information, multimedia, links to web-related content, blogs, and so on. In order to build or reflect these social networks or social relations among members, the social network system allows members to identify and establish links or connections with other members. For instance, in the context of a business network system (a type of social network system), a person may establish a link or connection with his or her business contacts, including work colleagues, clients, customers, personal contacts, and so on. With a social network system, a person may establish links or connections with his or her friends, family, or business contacts. While a social network system and a business network system may be generally described in terms of typical use cases (e.g., for personal and business networking, respectively), it will be understood by one of ordinary skill in the art that a business network system may be used for personal purposes (e.g., connecting with friends, classmates, former classmates, and the like) as well as or instead of business networking purposes and a social network system may likewise be used for business networking purposes as well as or in place of social networking purposes. A connection may be formed using an invitation process in which one member invites a second member to form a link. The second member then has the option of accepting or declining the invitation.

In general, a connection or link represents or is otherwise associated with an information access privilege, such that a first person who has established a connection with a second person is, via the establishment of that connection, authorizing the second person to view or access certain non-publicly available portions of their profiles that may include communications they have authored. Example communications may include blog posts, messages, wall postings, or the like. Depending on the particular implementation of the business/social network system, the nature and type of the information that may be shared, as well as the granularity with which the access privileges may be defined to protect certain types of data, may vary greatly.

Some social network systems may offer a subscription or following process to create a connection instead of or in addition to the invitation process. A subscription or following model is where one member follows another member without the need for mutual agreement. Typically in this model, the follower is notified of public messages and other communications posted by the member that is followed. An example social network system that follows this model is Twitter®, which is a micro-blogging service that allows members to follow other members without explicit permissions. Other, connection based social network systems also may allow following type relationships as well. For example, the social network system LinkedIn® allows members to follow particular companies.

A social network can generate revenue from content-based advertising, which can include posts or articles written and/or paid for by a sponsoring company. For example, a content advertiser can sponsor a series of posts on the social network, which can be engaged by members of the social network. The content advertiser wishes to understand the content that is prevalent on the social network, such as what topics are being posted, who is engaging with the posts, what is a profile of audience members that engage with the posts, how the topics and the audience are evolving over time, and so forth. Information about the trending topics on the social network can direct the content advertiser to produce content that is relevant to the audience, and can help the content advertiser ensure that the content evolves with the audience and remains relevant over time.

A social network can include a relatively large amount of content posted by its members and content-based advertisers, perhaps thousands or millions of posts per day. It can be beneficial to include a fully or partially automated mechanism that can analyze the posted content to determine trends over time. Examples of trends can include topics (e.g., what is the posted content about), audience (e.g., who is engaging with the posts), advertisers (e.g., what companies are sponsoring content), and engagement (e.g., with whom is the content resonating).

There are various ways to extract topics from the content on the social network, in an automated or semi-automated manner. For example, the social network can use natural language processing, data mining, and/or other computation-intensive techniques to extract topics from the text of text-based posts on the social network.

As an alternative to directly applying computation-intensive techniques to the content on the social network, the social network can use a clustering mechanism to analyze content posted on the social network. In a clustering technique, the social network compares the text of a post to a group of predefined properties or characteristics, and assigns one or more of the predefined properties to the post based on the comparison. Posts covering similar topics can have text that is similar, and can therefore be assigned similar properties from the group of predefined properties. The social network can extract a topic or topics of a post from the properties assigned to it.

One convenient group of properties to use for clustering is skills. In some examples, the skills assigned to a post can be drawn from skills associated with members' profiles on the social network. For these examples, the social network can include a relatively large and diverse collection of skills, which can cover most or all areas of expertise of the members of the social network. For example, some suitable skills can include cloud computing, C++ programming, advertising, digital media advertising, marketing, patent prosecution, sales, and others. Advantageously, the collection of skills can be updated automatically by the members, as the members update their profiles. For these examples, the social network can assign skills to posts on the social network, then extract topics of the posts based on the skills assigned to the posts.

Using one or more computation-intensive techniques and/or one or more clustering techniques, the social network can classify content, aggregate the topics of the content, and provide the topics to entities such as content-based advertisers. In some examples, the social network can analyze the topics over time to determine trending topics on the social network.

The social network can receive input from a receiving entity, which is an end user interested in content performance. Examples of receiving entities can include a user, a content-based advertiser, and others. The receiving entity can enter input through an interactive dashboard, which can prompt the receiving entity for information such as a desired audience, and/or one or more topics of interest, and can receive input from the receiving entity in response to the prompt or prompts.

There are various aspects to how the social network can present the topics to the receiving entity. In a first aspect, the receiving entity can specify a desired audience. The social network can provide topics that are trending with the desired audience. In some examples, the topics can be presented as ranked in descending order of a particular calculated quantity that indicates how well the topics are performing. In some examples, the social network can present links to posts on the social network and/or other pieces of content on the social network that cover the topics that reach the desired audience. In presenting the topics, the presentation to the receiving entity can be hierarchical. In presenting the content associated with the topics, the presentation to the receiving entity can be granular.

In a second aspect, the receiving entity can specify one or more topics that the receiving entity wants associated with the brand or product of the receiving entity. In some examples, the social network can provide a profile of a particular audience that is interested in the specified topic or topics and engages with the specified topic or topics. In some examples, the social network can provide and over- and under-indexation of the particular audience, compared with some or all other audiences on the social network. Such an indexation can tell the receiving entity what audience is reading the content of the receiving entity, and how much more (or less) likely that audience is likely to engage with the receiving entity's content when the content is associated with the specified topic or topics.

In a third aspect, the social network can provide a comparison factor against peers of the receiving entity. The comparison factor can tell the receiving entity how well the receiving entity is doing compared to peers or competitors that are trying to reach the same audience on the social network. In some examples, the comparison with competitors can include a percentage value that represents how more (or less) effective the receiving entity is at reaching the target audience, compared to one or more competitors.

From these three aspects, the social network can provide trending content in a manner that can advantageously combine indexing, engagement by topic, and ranking against competitors that are trying to reach a similar audience.

In some examples, to accomplish one or more of the above three aspects, the social network can present output to a receiving using a graphical user interface. The graphical user interface can include modules labeled as Learn, Explore, and Analyze.

In some examples, the Learn module can present a high-level view of what content is available on the social network.

In some examples, the Explore module can present examples of what other entities are doing on the social network. Such examples can benefit a new content advertiser on the social network. For example, the Explore module can show a new content advertiser how the social network can present one or more examples of topics by audience and/or by region and/or by type of company, performance benchmarks, and what actual content looks like on the social network. In some examples, the Explore module can show one or more screen shots of actual content on the social network.

In some examples, the Analyze module can show information specific to the receiving entity, and presented in a manner similar to the examples shown in the Explore module. In some examples, the Analyze module can tell the receiving entity how well the receiving entity's organic content is working, how well the receiving entity's sponsored content is working, and/or an over/under index based on how well the receiving entity is doing against the desired audience of the receiving entity. Much of the discussion that follows can pertain to presentation of information in the Analyze module. The Learn, Explore, and Analyze modules are but examples, and other suitable configurations can also be used.

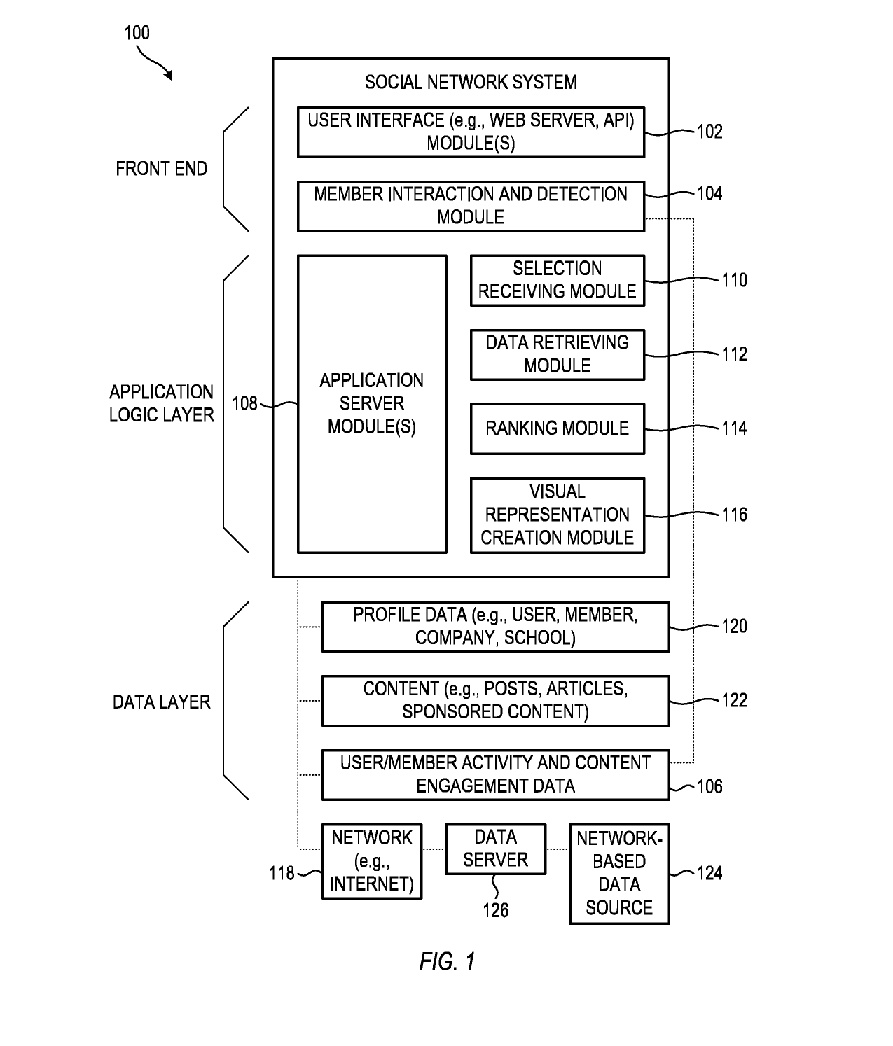

FIG. 1 is a block diagram showing the functional components of a social networking service 100, in accordance with some embodiments. As shown in FIG. 1, a front end may comprise a user interface module (e.g., a web server) 102, which receives requests from various client-computing devices, and communicates appropriate responses to the requesting client devices. For example, the user interface module(s) 102 may receive requests in the form of Hypertext Transport Protocol (HTTP) requests, or other network-based, application programming interface (API) requests (e.g., from a dedicated social networking service application running on a client device). In addition, a member interaction and detection module 104 may be provided to detect various interactions that members have with different applications, services and content presented. As shown in FIG. 1, upon detecting a particular interaction, the member interaction and detection module 104 logs the interaction, including the type of interaction and any metadata relating to the interaction, in a user/member activity and content engagement database 106.

An application logic layer may include one or more various application server modules 108, which, in conjunction with the user interface module(s) 102, generate various graphical user interfaces (e.g., web pages) with data retrieved from various data sources in the data layer. With some embodiments, application server module 108 is used to implement the functionality associated with various applications and/or services provided by the social networking service as discussed above.

The application logic layer can include a selection receiving module 110 configured to receive one or more selections on a user interface, such as 102. Examples of suitable selections can include a time frame, an audience, a topic, a sponsoring entity, and others. In some examples, selection receiving module 110 can present, via user interface module 102, a graphical user interface which can include one more pull-down menus, radio boxes, and the like, which each can receive a selection from a user of one of a predefined number of elements. In some examples, the graphical user interface can include one or more data entry regions, in which a user can enter an element, without selecting the element from a predefined list of elements. Other suitable forms of the graphical user interface can also be used.

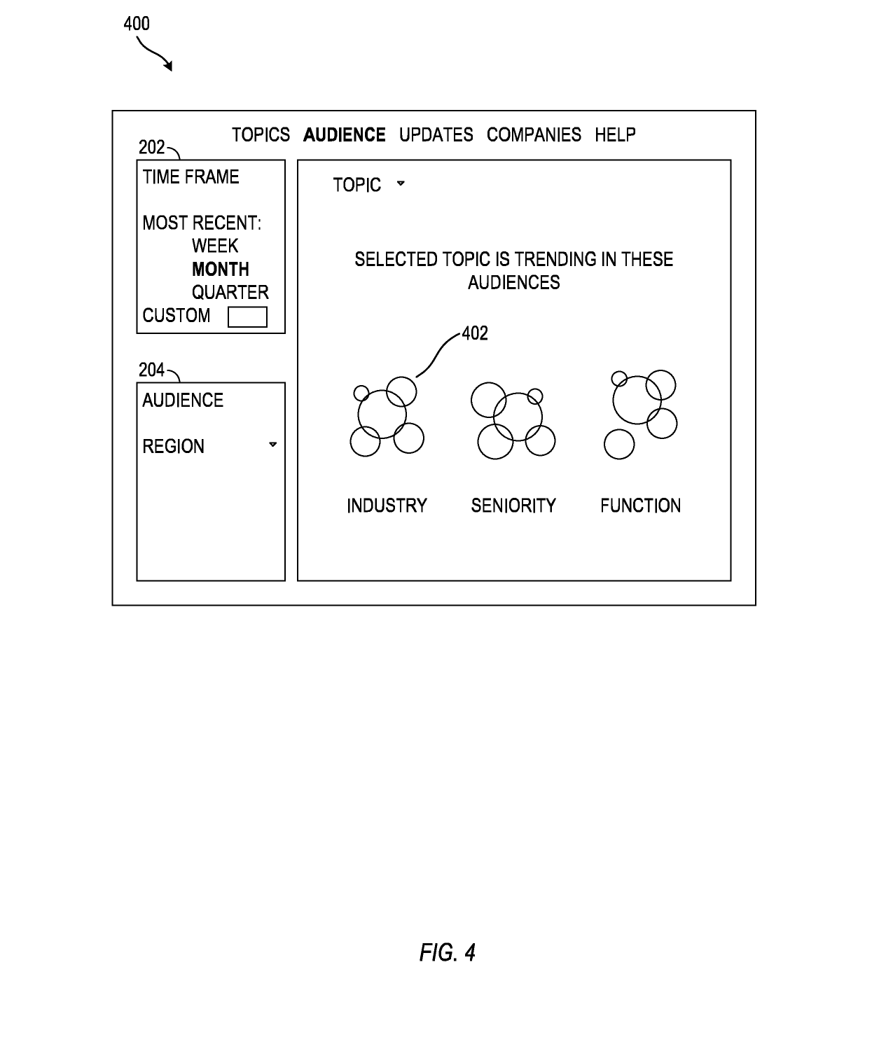

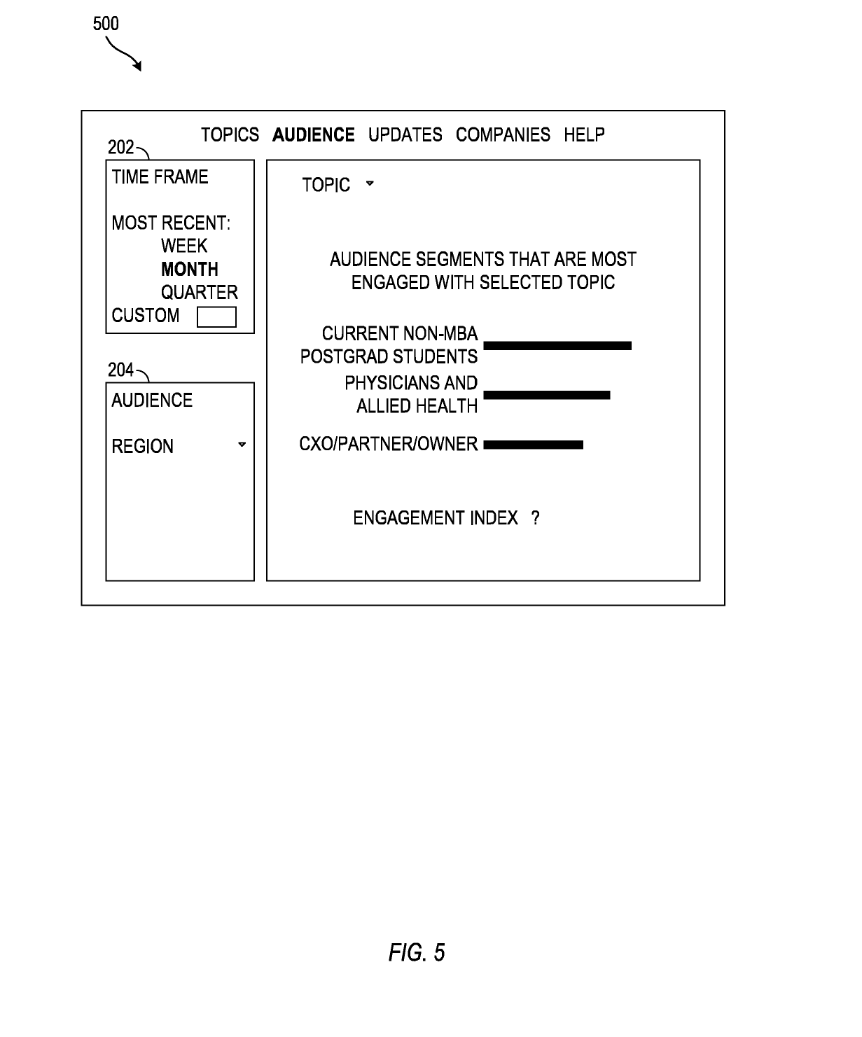

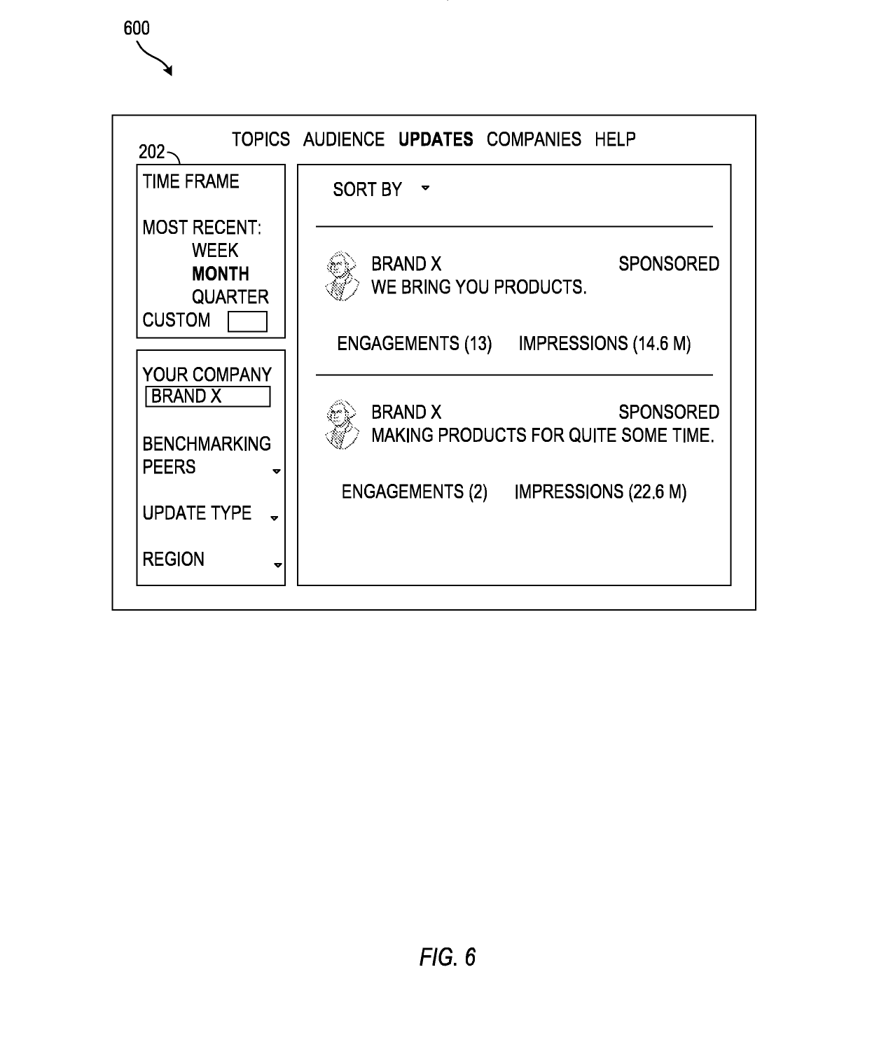

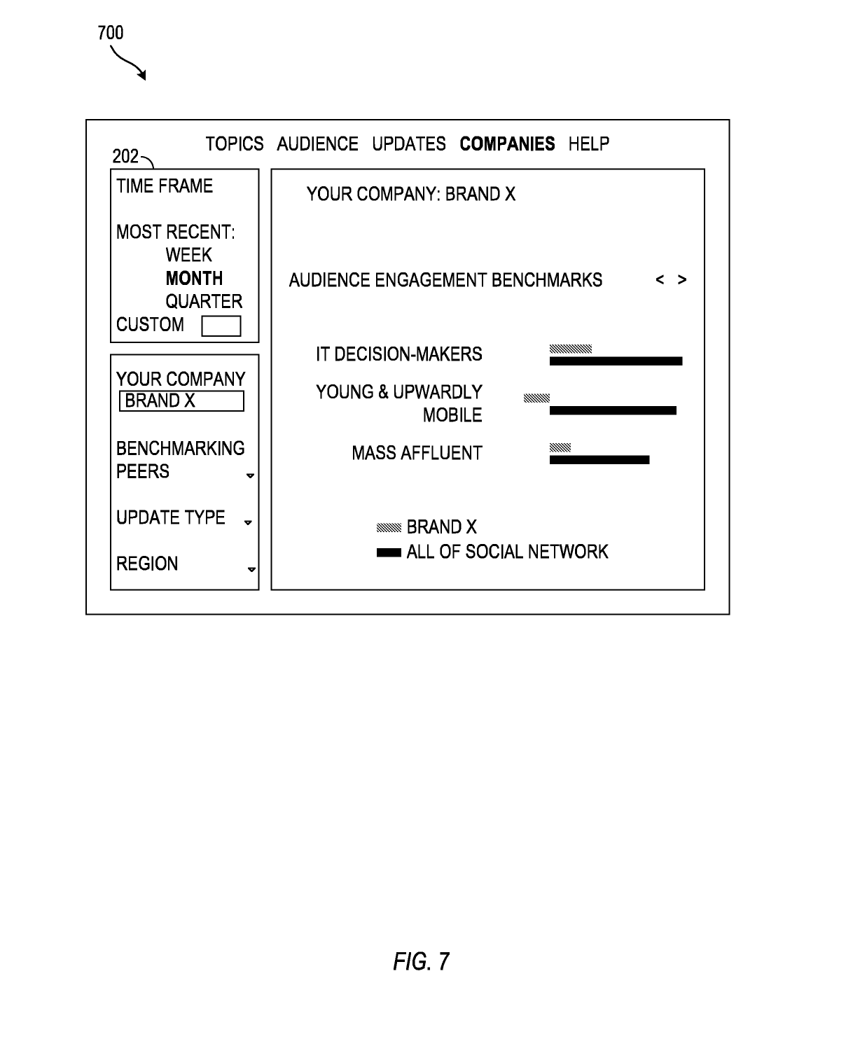

The application logic layer can include a data retrieving module 112 configured to retrieve, from the social network, topic data relating content to user engagement of the content during the selected time frame by the selected audience, where the content is categorized by topic. In some examples, such as in FIGS. 4 and 5 below, the data retrieving module 112 can be additionally configured to retrieve, from the social network, category data relating the content to user engagement of the content during the selected time frame, where the content is, categorized by topic. In some examples, such as in FIG. 6 below, the data retrieving module 112 can be additionally configured to retrieve, from the social network, engagement data relating sponsored content, sponsored by the sponsoring entity, to user engagement of the sponsored content during the selected time frame by users of the social network. In some examples, such as in FIG. 7 below, the data retrieving module 112 can be additionally configured to retrieve, from the social network, engagement data relating sponsored content, sponsored by the sponsoring entity, to user engagement of the sponsored content during the selected time frame by users of the social network.

The application logic layer can include a ranking module 114 configured to rank the topics, of the retrieved topic data, as a function of the user engagement. In some examples, such as in FIGS. 4 and 5 below, the ranking module can be additionally configured to rank category elements, of the retrieved category data, as a function of the user engagement for the selected topic. Examples of suitable categories can include a region, an audience segment, an industry, a function, a seniority, a company size, and others. For these examples, the category elements can include regions, audience segments, industries, functions, seniorities, and company sizes, respectively.

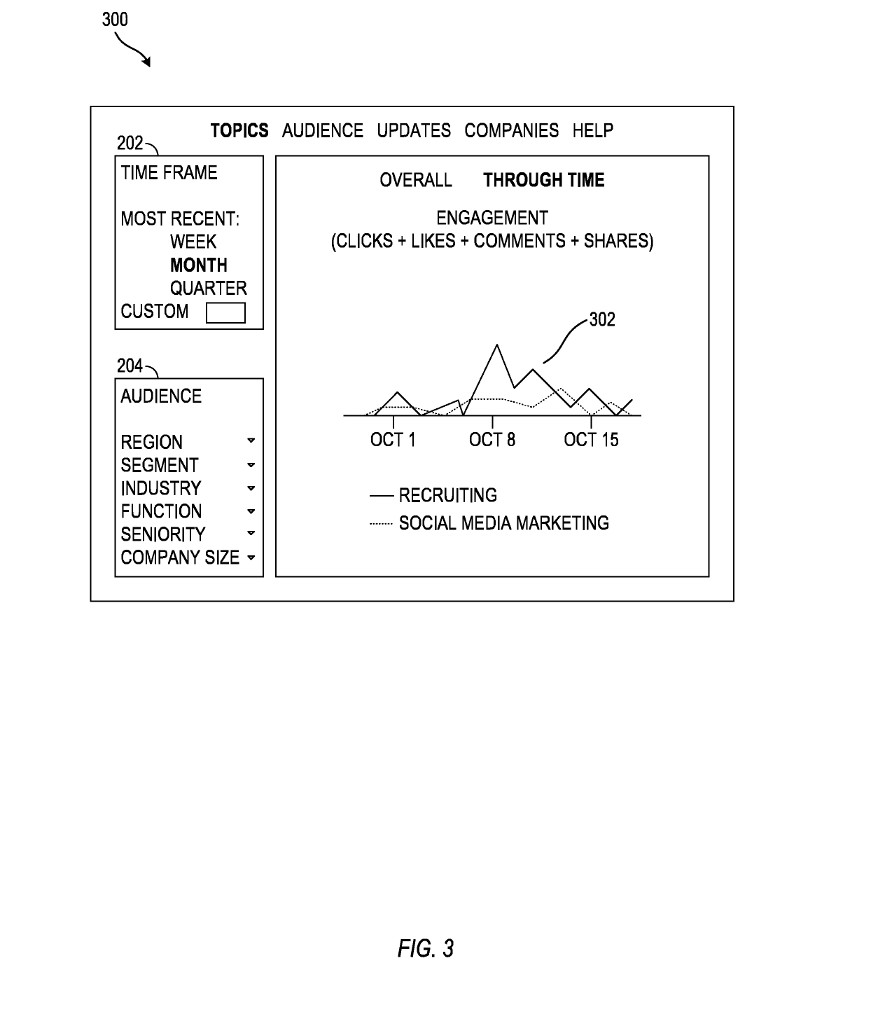

The application logic layer can include a visual representation creation module 116 configured to create one or more visual representations of the highest-ranked topics including indicia indicating relative levels of the user engagement for corresponding topics. In some examples, such as in FIG. 3 below, the visual representation creation module 116 can be additionally configured to create a second visual representation, from the retrieved topic data, including a plot of user engagement versus time for at least one of the topics, of the retrieved topic data. In some examples, such as in FIGS. 4 and 5 below, the visual representation creation module 116 can be additionally configured to create a category-specific visual representation of the highest-ranked first category elements including category-specific indicia indicating relative levels of the user engagement within corresponding first category elements. In some examples, such as in FIG. 6 below, the visual representation creation module 116 can be additionally configured to create a sponsor-specific visual representation of the engagement data including sponsor-specific indicia indicating levels of the user engagement for corresponding sponsored content. In some examples, such as in FIG. 7 below, the visual representation creation module 116 can be additionally configured create a comparison-specific visual representation of the compared engagement data including comparison indicia indicating levels of the user engagement for corresponding sponsored content and for all content for each of the plurality of audience categories. In some examples, the user interface 102 can display the visual representation, created by the visual representation creation module 116, to a user.

The modules 110, 112, 114, 116 can communicate with one or more network-based data sources 124, through one or more data servers 126, over a computer network (e.g., network 118) using standard network communication protocols and can programmatically (e.g., through an Application Programming Interface, abbreviated as API) access the network-based data source. In other examples, modules 110, 112, 114, 116 can access a public user interface (e.g., an HTML page). Modules 110, 112, 114, 116 can create one or more information records corresponding to each potential member profile attribute (e.g., for each publication, patent, and the like). The information records may contain one or more attributes of the possible member profile attributes that are collected from the network-based information source. Possible member profile attributes may correspond to member achievements.

The social networking service 100 may include a data layer that may include several other databases, such as a database 120 for storing profile data, including both member profile attributes as well as profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information can be stored, for example, in database 120. Similarly, when a representative of an organization initially registers the organization with the social networking service, the representative may be prompted to provide certain information about the organization. This information can be stored, for example, in database 120, or another database (not shown). With some embodiments, the profile data may be processed (e.g., in the background or offline) to generate various derived profile data. For example, if a member has provided information about various job titles that the member has held with the same company or different companies, and for how long, this information can be used to infer or derive a member profile attribute indicating the member's overall seniority level, or seniority level within a particular company. With some embodiments, importing or otherwise accessing data from one or more externally hosted data sources may enhance profile data for both members and organizations. For instance, with companies in particular, financial data may be imported from one or more external data sources, and made part of a company's profile.

User/member activity and content engagement database 106 can monitor and collect data regarding the various associations and relationships, such as connections that the members establish with other members. Also, as users or members interact with the various applications, services and content made available via the social networking service, user/member activity and content engagement database 106 can track, log, and store the members' interactions and behavior. For instance, user/member activity and content engagement database 106 can track, log, and store content viewed, links or buttons selected, messages responded to, and other interactions between members, or between members and content posted on the social network.

A content database 122 can store and maintain information describing content posted on the social network. For example, content database 122 can include information pertaining to each post or article posted on the social network. Such information can include the full text of the post, the author of the post, a sponsoring entity of the post, one or more topics included in the text of the post, and detailed information regarding members that engage with the post. Such members can be referred to as an audience. It is generally desirable to provide sponsoring entities detailed information about the audiences for their posts on the social network. The social network can use profile data, such as in database 120, to assemble the audience information for the sponsoring entities.

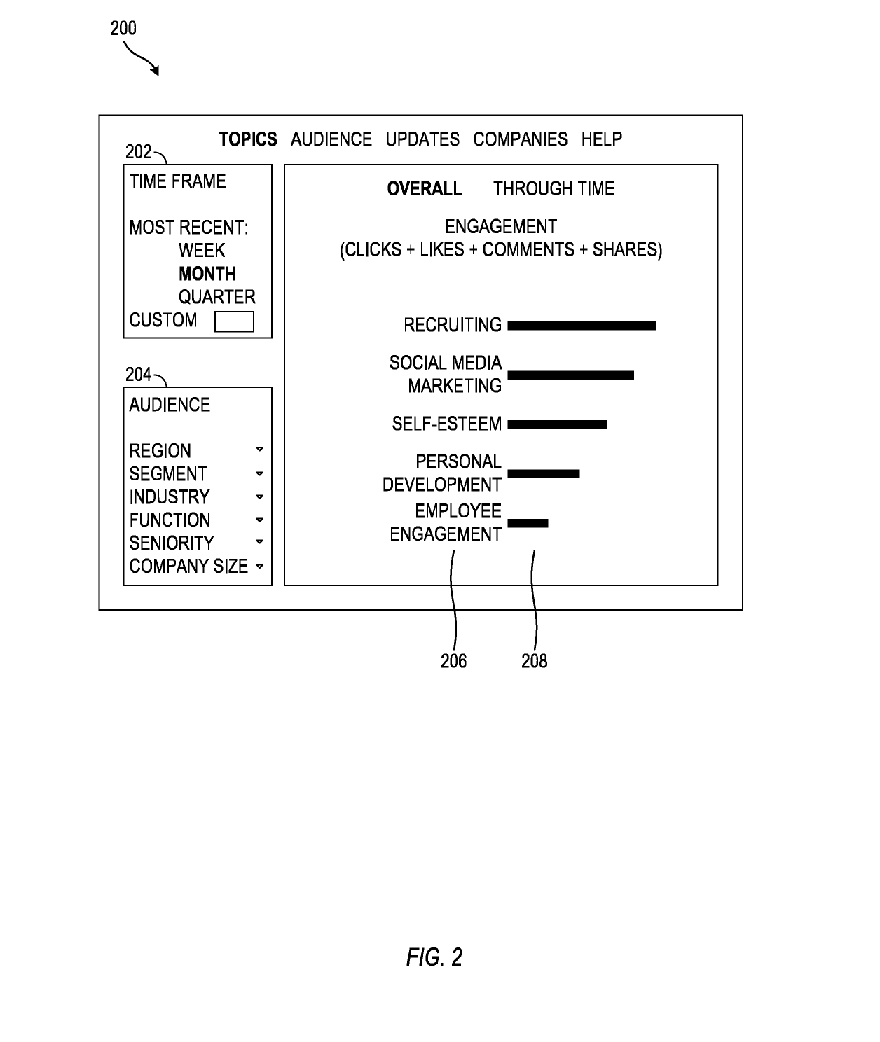

FIGS. 2-7 below shows examples of how social networking service 100 can analyze the audience information and present the audience information in a manner that can be easily and quickly interpreted by a user or a sponsoring entity. Each of FIGS. 2-7 shows an example of a screenshot, as displayed on a user interface, typically in a browser window, of a visual representation that displays particular audience information regarding content performance. In addition to the visual representation, the user interface can include various tabs, links, pull-down menus, selection boxes, and other elements that can prompt a user to specify the type of analysis performed, and the criteria used to refine the data in the analysis. In these examples, the visual representation occupies the center/right of the user interface, elements that can specify the type of analysis occupy the top of the user interface, and elements that can specify the data refinement criteria occupy the left of the user interface. Other positions are possible for these elements, as needed.

FIG. 2 shows an example of a user interface 200 showing a visual representation that displays performance of content (by topic) on a social network, in accordance with some embodiments. In the example of FIG. 2, the visual representation displays highest-ranked topics including indicia indicating relative levels of user engagement for the topics.

The user interface 200 can include a time frame portion 202 that can prompt a user to select a time frame over which the content performance can be analyzed. In the example of FIG. 2, the time frame portion 202 is positioned at the top/left of the user interface 200; in other examples, the time frame portion 202 can be positioned elsewhere in the user interface 200. In the example of FIG. 2, the user interface 200 can include selections for a most recent week, a most recent month, a most recent quarter (i.e., most recent three months), and a custom time frame. In the example of FIG. 2, a user has selected a most recent month, so that the visual representation displays how the content is performing only within the most recent month. Other selections can also be used, optionally including one or more time windows that may not extend to the present.

The user interface can include an audience portion 204 that can prompt a user to select an audience. The visual representation can display how the content is performing with users and/or members of the selected audience. The example of FIG. 2 includes six categories, through which a user can select an audience; other examples can include more or fewer than six categories. For instance, a user can select just a region, both a region and a segment (but no others), or any other suitable combination of the categories. The six categories shown in FIG. 2 are but mere examples, and a user interface can include any suitable mechanism for refining a selected audience.

In the example of FIG. 2, the selection of the audience by category can comprise a selection of one or more of a region, a segment, an industry, a function, a seniority, and a company size. These six categories of FIG. 2 are described below.

The selection of a region can comprise a selection of one or more countries from a specified list of countries in which users of the social network live. For example, the default selection in a list can include All Geography, with an option to check one or more boxes corresponding to countries, such as the United States, India, Brazil, United Kingdom, Canada, France, Italy, Mexico, Spain, Australia, and so forth. Other region selection mechanisms can also be used. In other examples, other granularities of geographical region may be selected, such as states, territories, cities, and the like.

The selection of a segment can comprise a selection of a segment from a specified list of segments, where a segment can be a portion of an audience specified by a category that can optionally be something other than an industry. For example, the default selection in a list can include All Segments, with an option to select a segment from a pull-down list of segments, such as CXO, Business Decision Makers, Manager+, Individual Contributors, SMB (1-200), SBO (1-200), ITDM, IT Function, Marketing Function, Sales Function, Financial Services Industry, High-Tech Industry, Institutional Inventors, Financial Advisors, Manufacturing Sector, Physicians And Allied Health, CXO/Partner/Owner, Career Changer, Ex-Pat Segment, Business Travelers, Company Changers, Opinion Leaders, Retirement, Young And Upwardly Mobile, Retirement Decision Makers, Mass Affluent, IT Committee, Current MBA Postgrad Students, Current non-MBA Postgrad Students, All Talent Professionals, and so forth. Other segment selection mechanisms can also be used.

The selection of an industry can comprise a selection of one or industries from a specified list of industries. For example, the default selection in a list can include All Industries, with an option to check one or more boxes corresponding to industries, such as Defense And Space, Computer Hardware, Computer Software, Computer Networking, Internet, Semiconductors, Telecommunications, Law Practice, Legal Services, Management Consulting, and so forth. Other industry selection mechanisms can also be used.

The selection of a function can comprise a selection of one or more functions from a specified list of functions. For example, the default selection in a list can include All Functions, with an option to check one or more boxes corresponding to functions, such as Accounting, Administrative, Arts And Design, Business Development, Community And Social Services, Consulting, Education, Engineering, Entrepreneurship, Finance, and so forth. Other function selection mechanisms can also be used.

The selection of a seniority can comprise a selection of one or more functions from a specified list of seniorities. For example, the default selection in a list can include All Seniorities, with an option to select a seniority from a pull-down list of seniorities, such as new hire, less than one year, between one and two years, between two and five years, between five and ten years, between ten and twenty years, and so forth. Other seniority selection mechanisms can also be used.

The selection of a company size can comprise a selection of one or more company sizes from a specified list of company sizes. For example, the default selection in a list can include All Sizes, with an option to select a company size from a pull-down list of company sizes, such as individual, between 2 and 5 employees, between 5 and 10 employees, between 10 and 20 employees, between 20 and 50 employees, between 50 and 100 employees, between 100 and 500 employees, between 500 and 5000 employees, greater than 5000 employees, and so forth. Other company size selection mechanisms can also be used.

Once a user has selected a timeframe and an audience, the processor can retrieve, from the social network, suitable data for the selected timeframe and audience. In some examples, at least one computer processor can retrieve, topic data relating the content to user engagement of the content during the selected time frame by the selected audience, where the content is categorized by topic. In the example of FIG. 2, user engagement can include a sum of one of more of clicks on the content, likes of the content, comments attached to the content, and shares of the content. This is but one example of a metric for numerically calculating user engagement; other suitable absolute or relative (e.g., scaled) metrics can also be used.

The computer processor can rank the topics, of the retrieved topic data, as a function of the user engagement. In the example of FIG. 2, recruiting is the highest-ranked topic (e.g., the topic having the highest user engagement, for the selected time frame and the selected audience), followed by social media marketing, self-esteem, personal development, and employee engagement.

The computer processor can create a visual representation of the highest-ranked topics including indicia indicating relative levels of the user engagement for corresponding topics. In the example of FIG. 2, the visual representation can include a list 206 of the highest-ranked topics, listed in descending order of user engagement and disposed in a linear list, displayed from top to bottom, such as with right-justification. In the example of FIG. 2, the corresponding indicia 208 can be disposed along adjacent to the list, such as with left-justification. In the example of FIG. 2, each of the indicia comprises a linear element having a length proportional to the respective user engagement. These are but examples; other display mechanisms can also be used.

The computer processor can display the visual representation to the user, such as through user interface 200. In some examples, when a cursor hovers over the linear element, the computer processor displays a numerical value corresponding to the respective user engagement and superimposed on the visual representation.

Whereas FIG. 2 shows content performance, summed or otherwise aggregated over a selected time frame (e.g., “Overall” in FIG. 2), FIG. 3 shows the same content displayed as a function of time (e.g., “Through Time” in FIG. 3).

FIG. 3 shows an example of a user interface 300 showing another visual representation that displays performance of content on the social network, in accordance with some embodiments. In the example of FIG. 3, the at least one computer processor can receive the selection of the time frame and the audience, can retrieve the topic data, can rank the topics, and can display a visual representation to the user in a manner similar to that described above for FIG. 2.

In the example of FIG. 3, the computer processor can create a second visual representation, from the retrieved topic data, including a plot 302 of user engagement versus time for at least one of the topics, of the retrieved topic data. The second visual representation can includes plots 302 for at least one of the highest-ranked topics, of the retrieved topic data. In the example of FIG. 3, the plot 302 can extend horizontally, with the left and right ends of the plot 302 corresponding to the beginning and ends of the selected time frame. This is but one example of plotting user engagement versus time for at least one of the topics; other suitable examples can also be used.

Whereas FIGS. 2 and 3 show content performance as a function of topic, for a well-defined audience, FIG. 4 shows how a single topic is trending with particular audiences, as a function of categories, such as industry, seniority, and function.

FIG. 4 shows an example of a user interface 400 showing another visual representation that displays performance of content on the social network, in accordance with some embodiments. In the example of FIG. 4, the at least one computer processor can receive a selection of a topic on user interface 400. In the example of FIG. 4, the user can optionally specify a category (e.g., in the example of FIG. 4, a region); in other example the user can specify no categories or multiple categories. The computer processor can retrieve, from the social network, category data relating the content to user engagement of the content during the selected time frame, where the content corresponds to the selected topic.

The computer processor can, for a first category, rank corresponding first category elements, of the retrieved category data, as a function of the user engagement for the selected topic. For instance, for a category of “industry”, the computer processor can rank industries as a function of user engagement of the selected topic. As an example, the computer processor can return Defense And Space, Computer Hardware, Computer Software as the three highest ranking industries, for the selected topic, for the selected time frame. This is but one specific example; other categories can also be used, including region, segment, function, seniority, company size, or other suitable categories. The computer processor can alternatively perform similar rankings for multiple categories.

The computer processor can create a category-specific visual representation of the highest-ranked first category elements including category-specific indicia indicating relative levels of the user engagement within corresponding first category elements. In the example of FIG. 4, each of the category-specific indicia comprises a two-dimensional element 402 having an area proportional to the respective user engagement. In a specific example, the indicia are circles having sizes that scale with user engagement. In some examples, each circle corresponds to a different industry, and the size of each circle is proportional to the respective engagement. In some examples, the visual representation can include multiple portions, with each portion corresponding to a different category. The computer processor can provide the category-specific visual representation to the user in a manner similar to that used for FIGS. 2-3.

Whereas FIG. 4 uses overlapping areas of variable size to show how a single topic is trending with particular audiences, as a function of category (e.g., in the example of FIG. 4, industry, seniority, and function), FIG. 5 uses a list and linear elements of variable length to show how a single topic is trending with particular audiences, as a function of category (e.g., in the example of FIG. 5, audience segment).

FIG. 5 shows an example of a user interface 500 showing another visual representation that displays performance of content on the social network, in accordance with some embodiments. In the example of FIG. 5, the at least one computer processor can receive the selection of the time frame and the audience, can retrieve the topic data, can rank the topics, and can display a visual representation to the user in a manner similar to that described above for FIG. 4.

In the example of FIG. 5, each of the category-specific indicia comprises a linear element having a length proportional to the respective user engagement. FIGS. 4 and 5 show two examples for displaying the ranked results; other suitable display mechanisms can also be used.

In some examples, the user interface 500 can include a help button that explains the engagement index used for user engagement. In some examples, the button can allow a user to specify or select one of several predefined engagement indices.

For an entity that is sponsoring content on the social network, it can be beneficial to view the performance of the entity's sponsored content, optionally compared to content provided by peers (e.g., competitors) of the sponsoring entity.

FIG. 6 shows an example of a user interface 600 showing another visual representation that displays performance of content on the social network, in accordance with some embodiments. In the example of FIG. 6, the at least one computer processor can receive a selection of a sponsoring entity on the user interface 600. In the example of FIG. 6, the user interface can provide a box, into which the user enters the company or other sponsoring entity. In other examples, the user interface can provide a pull-down menu for selecting a company, or a list with check-boxes for selecting multiple companies. In the example of FIG. 6, a user has entered “Brand X” as the company.

The user interface 600 can optionally provide for a selection of one or more benchmarking peers. In some examples, the benchmarking peers can be selected from a list. For example, a user can select from the list “Brand Y”, a fierce competitor of Brand X. The user interface 600 can optionally provide for selection of an update type, which can include posts, articles, advertisements, and so forth.

The computer processor can retrieve, from the social network, engagement data relating sponsored content, sponsored by the sponsoring entity, to user engagement of the sponsored content during the selected time frame by users of the social network.

The computer processor can create a sponsor-specific visual representation of the engagement data including sponsor-specific indicia indicating levels of the user engagement for corresponding sponsored content. In some examples, each of the sponsor-specific indicia comprises numerical values corresponding to user engagements and user impressions.

In the example of FIG. 6, the content can include a first advertisement from Brand X, which states, “We bring you products.” The first advertisement can be somewhat successful, generating 14.6 million impressions, and thirteen engagements. The content can also include a second advertisement from Brand X, which states, “Making products for quite some time.” The second advertisement can be less successful, generating 22.6 million impressions, and two engagements. Displaying the data in this manner can provide insight to what content topics are engaging a larger audience for the sponsoring entity, and what content topics are less engaging (e.g., engaging a smaller audience). In the specific example of FIG. 6, the user can learn that audiences don't seem to care how long Brand X has been making products, and can use this information to guide Brand X's future posting strategy on the social network.

In some examples, when a user selects one or more benchmarking peers (e.g., Brand Y), the content and associated user engagement data from the selected peers (Brand Y) can appear in addition to the data from the selected company (Brand X). This can allow for side-by-side comparison of a company (Brand X) to its benchmarking peers (Brand Y).

In some examples, the user interface 600 can allow for sorting of the content by various criteria, such as number of engagements, age of the content, company, and so forth.

Whereas FIG. 6 shows numerical performance of individual pieces of content from a company and its peers, FIG. 7 can compare performance of content for a company against its peers and/or against the full social network, for particular audience segments.

FIG. 7 shows an example of a user interface 700 showing another visual representation that displays performance of content on the social network, in accordance with some embodiments. In the example of FIG. 7, the at least one computer processor can receive a selection of a sponsoring entity on the user interface 700. The computer processor can retrieve, from the social network, engagement data relating sponsored content, sponsored by the sponsoring entity, to user engagement of the sponsored content during the selected time frame by users of the social network. The computer processor can compare user engagement of the sponsored content to user engagement of all content, for each of a plurality of audience categories.

The computer processor can create a comparison-specific visual representation of the compared engagement data including comparison indicia indicating levels of the user engagement for corresponding sponsored content and for all content for each of the plurality of audience categories. The indicia can provide clear visual indicators of whether the sponsoring entity outperforming competitors and/or the full social network. In the example of FIG. 7, the indicia include horizontally-oriented lines having a length corresponding to absolute or relative user engagement. In the example of FIG. 7, the top indicia, for Brand X, are relative, where a right-extending line indicates that Brand X outperforms all the social network for the corresponding audience segment, and a left-extending line indicates that Brand X underperform with respect to the social network for the corresponding audience segment. In the specific example of FIG. 7, content from Brand X outperforms content from the full social network with IT Decision-Makers and Mass Affluent people, and underperforms with Young And Upwardly Mobile people. The computer processor can display the comparison-specific visual representation to the user, in a manner similar to FIGS. 2-6.

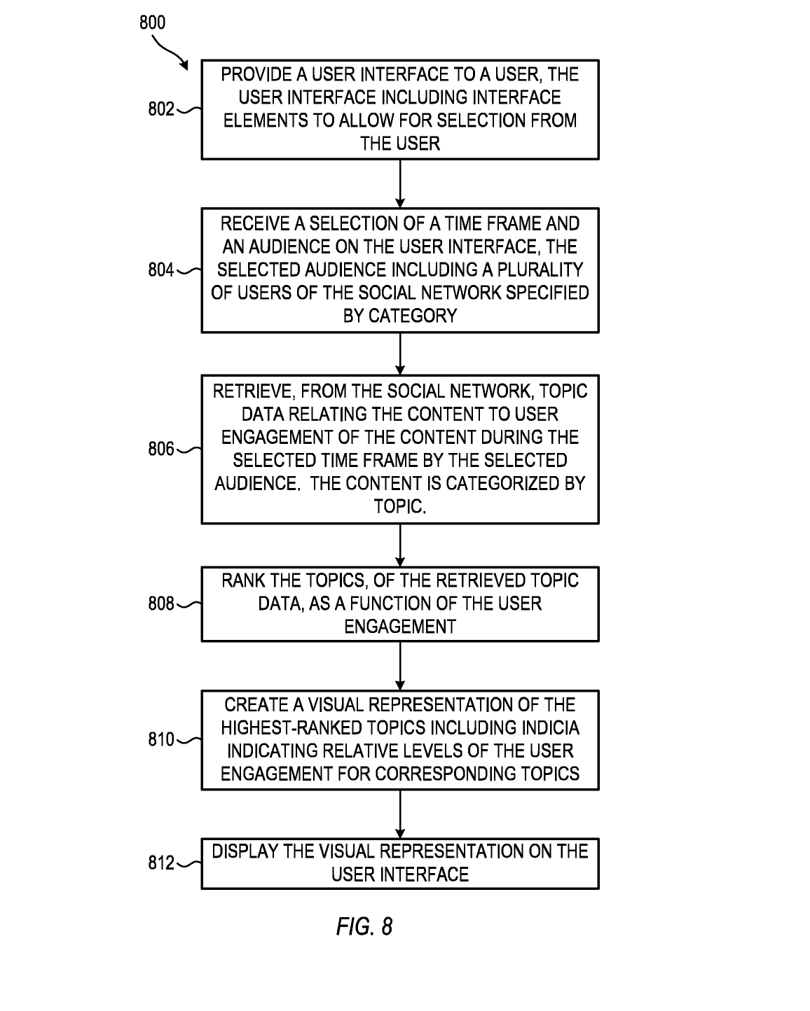

FIG. 8 shows an example of a method 800 for visually displaying performance of content on a social network, in accordance with some embodiments. The method can be executed by at least one computer processor, such as one or more application server modules 108 (FIG. 1). Method 800 is but one method for visually displaying performance of content on a social network; other suitable methods can also be used.

At operation 802, the at least one computer processor provide a user interface to a user. The user interface can include user interface elements to allow for selections from the user.

At operation 804, the at least one computer processor can receive a selection of a time frame and an audience on the user interface. The selected audience including a plurality of users of the social network specified by category.

At operation 806, the at least one computer processor can retrieve, from the social network, topic data relating the content, categorized by topic, to user engagement of the content during the selected time frame by the selected audience.

At operation 808, the at least one computer processor can rank the topics, of the retrieved topic data, as a function of the user engagement.

At operation 810, the at least one computer processor can create a visual representation of the highest-ranked topics including indicia indicating relative levels of the user engagement for corresponding topics.

At operation 812, the at least one computer processor can display the visual representation on the user interface.

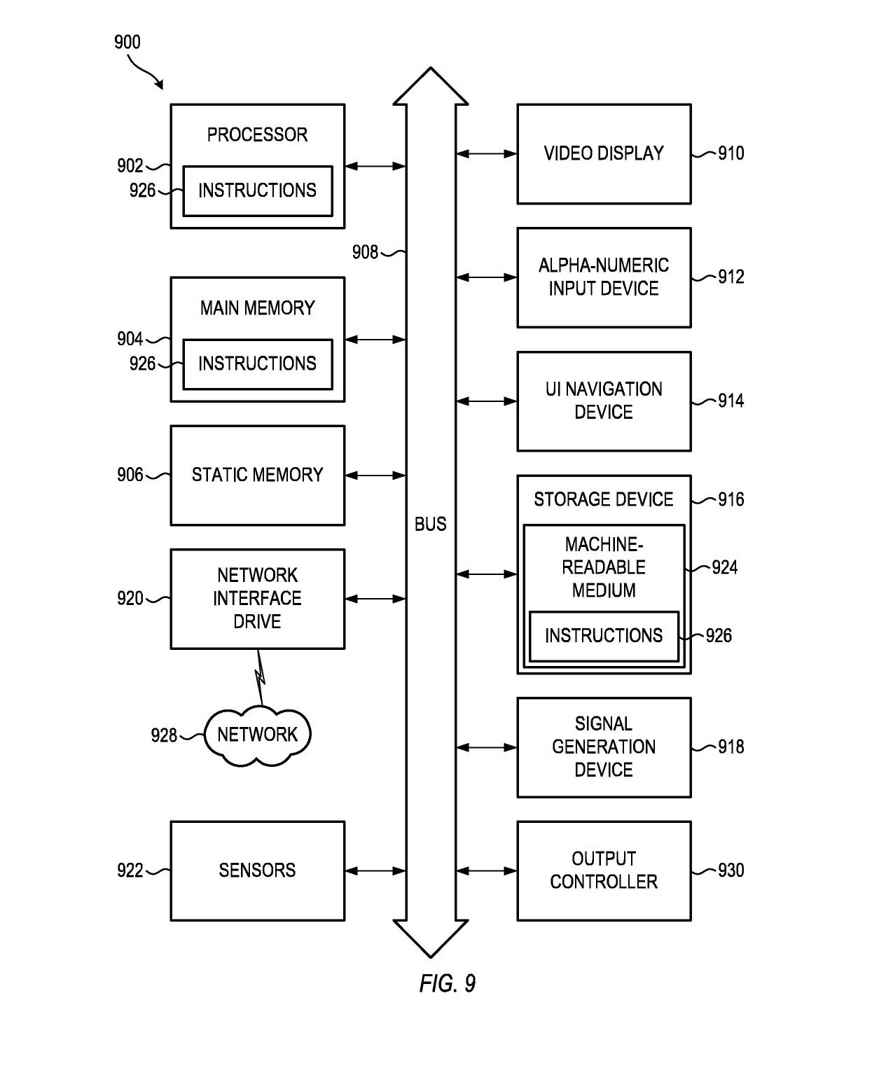

FIG. 9 illustrates a block diagram of an example of a machine 900 upon which any one or more of the techniques (e.g., methodologies) discussed herein may perform, in accordance with some embodiments. The components of FIG. 1 may execute upon and/or include one or more of the components in FIG. 1. In alternative examples, the machine 900 may operate as a standalone device or may be connected (e.g., networked) to other machines. In a networked deployment, the machine 900 may operate in the capacity of a server machine, a client machine, or both in server-client network environments. In an example, the machine 900 may act as a peer machine in peer-to-peer (P2P) (or other distributed) network environment. The machine 900 may be a server, personal computer (PC), a tablet PC, a set-top box (STB), a personal digital assistant (PDA), a mobile telephone, a smart phone, a web appliance, a network router, switch or bridge, a component of a social networking service, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules include a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 900 may include a hardware processor 902 (e.g., a central processing unit (CPU), a graphics processing unit (GPU), a hardware processor core, or any combination thereof), a main memory 904 and a static memory 906, some or all of which may communicate with each other via an interlink (e.g., bus) 908. The machine 900 may further include a display unit 910, an alphanumeric input device 912 (e.g., a keyboard), and a user interface (UI) navigation device 914 (e.g., a mouse). In an example, the display unit 910, input device 912 and UI navigation device 914 may be a touch screen display. The machine 900 may additionally include a storage device (e.g., drive unit) 916, a signal generation device 918 (e.g., a speaker), a network interface device 920, and one or more sensors 922, such as a global positioning system (GPS) sensor, compass, accelerometer, or other sensor. The machine 900 may include an output controller 930, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 916 may include a machine readable medium 924 on which is stored one or more sets of data structures or instructions 926 (e.g., software) embodying or utilized by any one or more of the techniques or functions described herein. The instructions 926 may also reside, completely or at least partially, within the main memory 904, within static memory 906, or within the hardware processor 902 during execution thereof by the machine 900. In an example, one or any combination of the hardware processor 902, the main memory 904, the static memory 906, or the storage device 416 may constitute machine readable media.

While the machine readable medium 924 is illustrated as a single medium, the term “machine readable medium” may include a single medium or multiple media (e.g., a centralized or distributed database, and/or associated caches and servers) configured to store the one or more instructions 926.

The term “machine readable medium” may include any medium that is capable of storing, encoding, or carrying instructions for execution by the machine 900 and that cause the machine 900 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 926 may further be transmitted or received over a communications network 928 using a transmission medium via the network interface device 920. The machine 900 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 920 may include one or more physical jacks (e.g., Ethernet, coaxial, or phone jacks) or one or more antennas to connect to the communications network 928. In an example, the network interface device 920 may include a plurality of antennas to wirelessly communicate using at least one of single-input multiple-output (SIMO), multiple-input multiple-output (MIMO), or multiple-input single-output (MISO) techniques. In some examples, the network interface device 920 may wirelessly communicate using Multiple User MIMO techniques.

What is claimed is:

1. A method for visually displaying performance of content on a social network, the method comprising:
using at least one computer processor to:
provide a user interface to a user, the user interface including user interface elements to allow for selections from the user;
receive a selection of a time frame and an audience on the user interface, the selected audience including a plurality of users of the social network specified by category;
retrieve, from the social network, topic data relating the content to user engagement of the content during the selected time frame by the selected audience, wherein the content is categorized by topic;
rank the topics, of the retrieved topic data, as a function of the user engagement;
create a visual representation of the highest-ranked topics including indicia indicating relative levels of the user engagement for corresponding topics; and
display the visual representation on the user interface.

2. The method of claim 1, wherein each of the indicia comprises a linear element having a length proportional to the respective user engagement.

3. The method of claim 1, wherein the selection of the audience by category comprises a selection of one or more of a region, a segment, an industry, a function, a seniority, and a company size.

4. The method of claim 3, wherein the selection of a region comprises a selection of one or more countries from a specified list of countries in which users of the social network live.

5. The method of claim 3, wherein the selection of a segment comprises a selection of a segment from a specified list of segments.

6. The method of claim 3, wherein the selection of an industry comprises a selection of one or industries from a specified list of industries.

7. The method of claim 3, wherein the selection of a function comprises a selection of one or more functions from a specified list of functions.

8. The method of claim 1, further comprising:
using the at least one computer processor to further:
create a second visual representation, from the retrieved topic data, including a plot of user engagement versus time for at least one of the topics, of the retrieved topic data; and
display the second visual representation on the user interface.

9. The method of claim 8, wherein the second visual representation includes plots for at least one of the highest-ranked topics, of the retrieved topic data.

10. The method of claim 1, further comprising:
using the at least one computer processor to further:
receive a selection of a topic on the user interface;
retrieve, from the social network, category data relating the content to user engagement of the content during the selected time frame, wherein the content corresponds to the selected topic;
for a first category, rank corresponding first category elements, of the retrieved category data, as a function of the user engagement for the selected topic;
create a category-specific visual representation of the highest-ranked first category elements including category-specific indicia indicating relative levels of the user engagement within corresponding first category elements; and
display the category-specific visual representation on the user interface.

11. The method of claim 10, wherein the first category comprises one of a region, an audience segment, an industry, a function, a seniority, or a company size.

12. The method of claim 10, wherein each of the category-specific indicia comprises a two-dimensional element having an area proportional to the respective user engagement. 13 The method of claim 10, wherein each of the category-specific indicia comprises a linear element having a length proportional to the respective user engagement.

14. The method of claim 1, further comprising:
using the at least one computer processor to further:
receive a selection of a sponsoring entity on the user interface;
retrieve, from the social network, engagement data relating sponsored content, sponsored by the sponsoring entity, to user engagement of the sponsored content during the selected time frame by users of the social network;
create a sponsor-specific visual representation of the engagement data including sponsor-specific indicia indicating levels of the user engagement for corresponding sponsored content; and
display the sponsor-specific visual representation on the user interface.

15. The method of claim 14, wherein each of the sponsor-specific indicia comprises numerical values corresponding to user engagements and user impressions.

16. The method of claim 1, further comprising:
using the at least one computer processor to further:
receive a selection of a sponsoring entity on the user interface;
retrieve, from the social network, engagement data relating sponsored content, sponsored by the sponsoring entity, to user engagement of the sponsored content during the selected time frame by users of the social network;
compare user engagement of the sponsored content to user engagement of all content, for each of a plurality of audience categories;
create a comparison-specific visual representation of the compared engagement data including comparison indicia indicating levels of the user engagement for corresponding sponsored content and for all content for each of the plurality of audience categories; and
display the comparison-specific visual representation on the user interface.

17. A social network system for visually displaying performance of content on the social network, the system comprising:
at least one processor; and
memory, including instructions that, when executed on the at least one processor, cause the at least one processor to:
provide a user interface to a user, the user interface including user interface elements to allow for selections from the user;
receive a selection of a time frame and an audience on the user interface, the selected audience including a plurality of users of the social network specified by category;
retrieve, from the social network, topic data relating the content to user engagement of the content during the selected time frame by the selected audience, wherein the content is categorized by topic;
rank the topics, of the retrieved topic data, as a function of the user engagement;
create a visual representation of the highest-ranked topics including indicia indicating relative levels of the user engagement for corresponding topics; and
display the visual representation on the user interface.

18. The system of claim 17, wherein:
the selection of the audience by category comprises a selection of one or more of a region, a segment, an industry, a function, a seniority, and a company size;
the selection of a region comprises a selection of one or more countries from a specified list of countries in which users of the social network live;
the selection of a segment comprises a selection of a segment from a specified list of segments;
the selection of an industry comprises a selection of one or industries from a specified list of industries; and
the selection of a function comprises a selection of one or more functions from a specified list of functions.

19. A non-transitory machine-readable medium, including instructions, which when executed by the machine, cause the machine to perform operations for visually displaying relationships among companies, the companies having employees that are members of a social network, the operations comprising:
providing a user interface to a user, the user interface including user interface elements to allow for selections from the user;
receiving a selection of a time frame and an audience on the user interface, the selected audience including a plurality of users of the social network specified by category;
retrieving, from the social network, topic data relating the content to user engagement of the content during the selected time frame by the selected audience, wherein the content is categorized by topic;
ranking the topics, of the retrieved topic data, as a function of the user engagement;
creating a visual representation of the highest-ranked topics including indicia indicating relative levels of the user engagement for corresponding topics; and
providing the visual representation on the user interface.

20. The non-transitory machine-readable medium of claim 19, wherein:
the selection of the audience by category comprises a selection of one or more of a region, a segment, an industry, a function, a seniority, and a company size;
the selection of a region comprises a selection of one or more countries from a specified list of countries in which users of the social network live;
the selection of a segment comprises a selection of a segment from a specified list of segments;
the selection of an industry comprises a selection of one or industries from a specified list of industries; and
the selection of a function comprises a selection of one or more functions from a specified list of functions.
